(19) United States
(12) Patent Application Publication
(10) Pub. No.: US 2011/0259511 A1
(43) Pub. Date: Oct. 27, 2011

(54) METHOD AND SYSTEM FOR MONITORING AND CONTROLLING THE MANUFACTURING OF PARTS FOR A WIND POWER PLANT

(75) Inventors: Dennis André Børsting, Kolding (DK); Qinyin Zhou, Arslev (DK); Jacobus Johannes Van Der Zee, Kolbing (DK)

(73) Assignee: LM GLASFIBER A/S, Kolding (DK)

(21) Appl. No.: 13/128,868

(22) PCT Filed: Nov. 11, 2009
(86) PCT No.: PCT/EP2009/064992

§ 371 Date: Jul. 18, 2011

(30) Foreign Application Priority Data
Nov. 12, 2008 (DK) PA 2008 01566

(51) Int. Cl. B29C 70/30

(52) U.S. Cl. 156/243; 156/378

(57) ABSTRACT

A method for monitoring and controlling that a plurality of layers (2) of material comprising fibre for the manufacturing of a part are located correctly in a mould (1) for said part and/or correctly relative to each other in said mould, comprises determining the position in the mould of each marking (7) on each layer (2) of fibre material and/or the positions of the markings on different layers of fibre material relative to each other, comparing the determined position in the mould (1) of each marking (7) on each layer (2) of fibre material and/or the positions of the markings on said different layers of fibre material relative to each other with predetermined reference positions for said markings for the part to be manufactured, and performing correction of the position of that or those layers (2) of fibre material for which the determined positions for the markings (7) thereon and the predetermined reference positions for said markings do not correspond with each other. A system comprises means for carrying through said method.

### BACKGROUND TO THE INVENTION

The present invention relates to a method for, during manufacturing of a fibre-reinforced part for a wind power plant, monitoring and controlling that a plurality of layers of material comprising fibre for the manufacturing of said part are located correctly in a mould for said part and/or correctly relative to each other in said mould. The present invention also relates to a system which is used for carrying through said method.

In the context of manufacturing fibre-reinforced parts, such as blades for wind power plants, a manufacturing process is typically employed in which the part is moulded in two halves in each their open mould, wherein a coat, e.g. a gelcoat, is initially applied onto the interior surface of the open mould.

A number of layers of fibre material are subsequently arranged in the mould, typically by hand, following which resin is finally applied to attach the individual layers of fibre material to each other. The resin can be applied to the layers manually by RTM (resin transfer moulding), VARTM (vacuum assisted resin transfer moulding) or other suitable methods. Alternatively, the resin can be applied to the laminate layers (Prepeg). In the context of this, gelcoat will harden and form the surface of the product.

Arranging the layers of fibre material in the mould is today a time-consuming and labour intensive process. Depending on the size of the part to be manufactured, walkways may be arranged alongside and/or above the mould such that the workers are allowed to walk along the edge or periphery of the mould and/or above the mould in order to arrange the layers of fibre material as required.

Multiple rolls of fibre material comprising different types of fibre material are arranged on the walkways, such that the workers may pick suitable rolls comprising the required materials and arrange the materials on the form.

During the layup of fibre material, combined efforts of several workers are required, as the fibre material is heavy and not easy manipulable. Some workers assist in the rollout of material, while other workers positioned along the edges of the mould make sure that the layers are laid up correctly.

Depending on the application and structure of the part to be manufactured, multiple layers of fibre material may be arranged in the mould and the layers are typically arranged on top of each other or next to each other or possibly with overlapping edges.

The parts typically consist of as many as fifty or more layers of fibre material and the parts are typically built up from a main laminate provided in the centre of the mould. Between the layers of fibre material there may also be provided layers of e.g. balsa wood for providing suitable distances between said layers of fibre material.

After a layer which is provided from a roll is located in the mould, the material is cut from the roll. Manufacturing of parts having curvature throughout the length of the part, such as a wing or blade for a wind power plant, may require very long cuts along the edges of the mould.

Moulds for manufacturing such parts may be very large and the moulds are as a consequence expensive. The time required for the arrangement of material in the mould should be kept at a minimum such that the form time (the time which a part occupies the mould) required by a part to be manufactured is kept at a minimum, thus increasing the overall productivity of the mould.

The fibre material is preferably arranged substantially even and flush, which is why any developed dents and curls etc. must be smoothed out. Further, as one layer is typically applied on top of a preceding layer, the lower layer as well as possible additional layers arranged below the lower layer tend to move or slide within the mould, causing the entire layup of fibre material to move away from an intended position in the mould. Also, as various types of layers of fibre material are often laid laterally displaced relative to lower layers according to certain predetermined specifications for the part to be manufactured, it is important for the stability of said part that all layers are correctly displaced in the mould as well as relative to each other and without dents and the like.

### BRIEF SUMMARY OF THE INVENTION

The object of the present invention is accordingly to provide a method and system for facilitating and accelerating the manufacturing of parts for a wind power plant, such as a blade therefore, by having a better and more reliable control over the process of how the layers of material are located and corrected if not located properly.

This is arrived at according to the invention by, after having provided each layer of fibre material with at least one marking and while locating the layers of fibre material on top of each other or next to each other or with overlapping edges in the mould, determining the position in the mould of each marking on each layer of fibre material and/or the positions of the markings on different layers of fibre material relative to each other, comparing the determined position in the mould of each marking on each layer of fibre material and/or the positions of the markings on said different layers of fibre material relative to each other with predetermined reference positions for said markings for the part to be manufactured, and performing correction of the position of that or those layers of fibre material for which the determined positions for the markings thereon and the predetermined reference positions for said markings do not correspond with each other.

The system according to the invention comprises, while each layer of fibre material is provided with at least one marking and while the layers of fibre material are being located on top of each other or next to each other or with overlapping edges in the mould, means for determining the position in the mould of each marking on each layer of fibre material and/or the positions of the markings on different layers of fibre material relative to each other, means for comparing the determined position in the mould of each marking on each layer of fibre material and/or the positions of the markings on said different layers of fibre material relative to each other with predetermined reference positions for said markings for the part to be manufactured, and means for performing correction of the position of that or those layers of fibre material for which the determined positions for the markings thereon and the pre-determined reference positions for said markings do not correspond with each other.

Other objects and advantages of the invention will be apparent to one skilled in the art who examines the attached drawings and the following detailed description of preferred embodiments.

### BRIEF DESCRIPTION OF THE DRAWING

FIG. 1 is a schematic sectional view of a part of an open mould for moulding a part for a wind power plant, said mould being provided with a system according to the present invention.

### DETAILED DESCRIPTION OF PREFERRED EMBODIMENT OF THE INVENTION

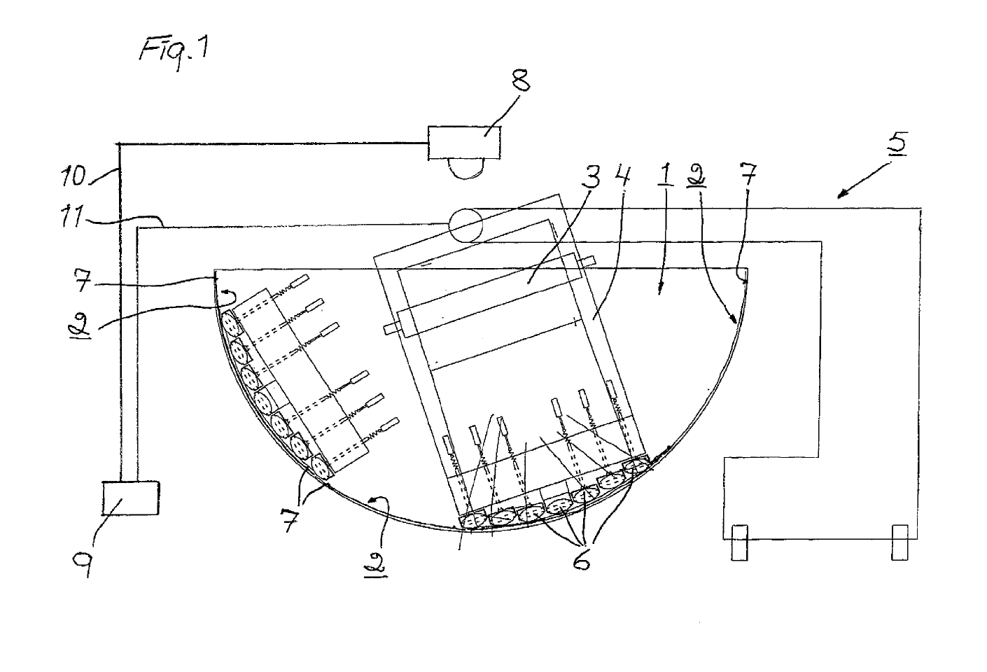

Thus, FIG. 1 is a sectional view of an open mould 1 which as illustrated accommodates a plurality of layers 2 of material comprising fibre for manufacturing a fibre-reinforced part for a wind power plant, e.g. a blade for said wind power plant. The layers 2 are illustrated as having a width or breadth corresponding substantially to one quarter of the breadth of the curved interior surface of the mould 1 and they are located next to each other. The layers 2 could however equally have been located on top of each other or with overlapping edges.

The mould 1 is typically an elongated mould having a length corresponding substantially to the length of the part to be manufactured from, inter alia, the layers 2.

The layers 2 may constitute pre-cut pieces intended for a particular site of application in the mould 1 and the pieces may be rolled onto a roll 3. Further, the fibre material may simply constitute an endless length of material being rolled onto a roll 3 which, when arranged in or on the mould 1, is cut from the roll.

The roll 3 is as illustrated mounted on the frame 4 of a movable device 5 for locating the layers 2 of fibre material in the mould 1, said device thereby further comprising a number of adjustable press rolls 6. The construction and function of said movable device 5 do not form part of the present invention and will therefore not be further described here.

As stated above and with further reference to the drawing, the present invention relates to a method and a system for monitoring and controlling that said plurality of layers 2 of fibre material for manufacturing said part of the wind power plant are located correctly in the mould 1 for said part and/or correctly relative to each other in said mould. This is done simultaneously with the manufacturing of said part, i.e. while one layer 2 after the other of said fibre material is located in the mould 1. This means that each new layer 2 is monitored and controlled continuously during location thereof in the mould 1 and/or after said location thereof in the mould.

The layers 2 of fibre material used in the method and at the system according to the present invention are all provided with at least one marking 7 of a suitable type. The markings 7 can be provided when the layers 2 of fibre material are manufactured, at the manufacturer, or just before the location thereof in a mould 2. The markings 7 can also be provided on the rolls of fibre material from which the layers 2 are cut. The markings 7, which e.g. can be provided adjacent one or, as illustrated, both the longitudinal edges of each layer 2 of fibre material, may be provided thereon e.g. by printing or spraying and may thereby be designed e.g. as one or more broken or solid lines, eventually also in different colours. The markings 7 may alternatively be made e.g. of threads which are woven into the fibre material of said layers 2. Other types of markings 7 and other locations thereof on the layer 2 of fibre material can be provided. Common to all types of markings 7 however, is that they must be detectable by suitable means such that their positions in the mould 1 and/or relative to each other can be determined.

The layers 2 of fibre material, provided with markings 7 of a suitable type are as stated above located one by one on top of each other, next to each other as illustrated or with overlapping edges during manufacturing of the part to be manufactured. The markings 7 will thereby be positioned in accordance therewith.

In the method and at the system according to the present invention, the position of each marking 7 on each layer 2 of fibre material is determined during and/or after location of said layer in the mould 1. Accordingly, the procedure of determining the position of each marking 7 may be repeated one or more times for all layers 2 of fibre material such that the position of each layer 2 can be monitored continuously during and/or after location thereof in the mould 1. In the latter case eventually at the same time the next layer 2 of fibre material is located in the mould 1. The positions of the markings 7 in the mould 1 are determined. Alternatively, or as a complement to the above determination, the relative positions of the markings 7 on the different layers 2 of fibre material are determined. The positions of the markings 7 are determined e.g. as illustrated by means of a camera 8 or by means of a laser. With the camera 8, one or more pictures are taken for each new layer 2 of fibre material which is located in the mould 1. The pictures taken with the camera 8 can be used e.g. as subsequent documentation to the customer that the part to be manufactured in fact has been manufactured properly in the mould 1.

The determined position in the mould 1 of each marking 7 on each layer 2 of fibre material and/or the positions of the markings on different layers of fibre material relative to each other are then compared with predetermined reference positions for said markings for the part to be manufactured. This comparison is performed by means of e.g. a computer 9, in which said predetermined reference positions are stored. The computer 9 cooperates with the camera 8 or laser in a suitable manner, e.g. through a signal line 10, such that it continuously receives information about the determined actual positions of the markings 7 on the layers 2 of fibre material which are located in the mould 1 and/or of the positions of said markings on said different layers of fibre material relative to each other.

Finally, after said comparison of the determined positions of the markings 7 on the layers 2 of fibre material with said predetermined reference positions, correction of the position of that or those layers of fibre material for which the determined positions for the markings thereon and the predetermined reference positions for said markings do not correspond with each other, is performed. This correction can be performed in any suitable way with any appropriate means therefor. Appropriate means may e.g. be found on said device 5 for the initial location of the layers 2 of fibre material in the mould 1, might even consist of said device or apparatus, which then cooperates with the computer 9 through e.g. a signal line 11. As with the preceding steps of the method according to the present invention, correction can be performed either continuously, without interrupting the manufacturing of the part to be manufactured, or alternatively after first having interrupted said manufacturing.

The method described above can be performed manually or automatically.

It is obvious to a skilled person that the method and system according to the present invention can be modified or altered within the scope of the subsequent claims. Thus, all means, members or components mentioned above for determining the positions of the markings 7 on the layers 2 of fibre material, for comparing said determined positions of the markings with the predetermined reference positions for said markings and for performing correction of those layers of fibre material which are not properly located, can be replaced by other such means, members or components. Further, it is e.g. possible to perform, if not all the steps mentioned above, then at least one or more thereof without interrupting the manufacturing of the part to be manufactured, or to perform one or more of said steps while simultaneously locating the layers of fibre material, or to perform one or more steps automatically and other steps manually.

1. A method for, during manufacturing of a fibre-reinforced part for a wind power plant, monitoring and controlling that a plurality of layers of material comprising fibre for the manufacturing of said part are located correctly in a mould for said part and/or correctly relative to each other in said mould, the method comprising:
after having provided each layer of fibre material with at least one marking and while locating the layers of fibre material on top of each other or next to each other or with overlapping edges in the mould, determining the position in the mould of each marking on each layer of fibre material and/or the positions of the markings on different layers of fibre material relative to each other,
comparing the determined position in the mould of each marking on each layer of fibre material and/or the positions of the markings on said different layers of fibre material relative to each other with predetermined reference positions for said markings for the part to be manufactured, and
performing correction of the position of that or those layers of fibre material for which the determined positions for the markings thereon and the predetermined reference positions for said markings do not correspond with each other.

2. The method according to claim 1, characterized by performing said method without interrupting the manufacturing of the part to be manufactured.

3. The method according to claim 1, characterized by performing said method after interruption of the manufacturing of the part to be manufactured.

4. The method according to claim 2, characterized by performing said method continuously during and/or after location of each layer of fibre material.

5. The method according to claim 2, characterized by performing said method after location of each layer of fibre material.

6. The method according to claim 1, characterized by performing said method automatically.

7. The method according to claim 1, characterized by providing the markings on the layers of fibre material adjacent one of or both of the longitudinal edges of each layer of material.

8. The method according to claim 1, characterized by printing or spraying the markings on the layers of fibre material.

9. The method according to claim 1, characterized by designing the markings on the layers of fibre material as one or more broken or solid lines.

10. The method according to claim 9, by designing the markings on the layers of fibre material as one or more broken or solid lines in different colours.

11. The method according to claim 1, characterized by making the markings on the layers of fibre material of threads woven into the material of said layers.

12. The method according to claim 1, characterized by determining the positions of the markings on the layers of fibre material by means of a camera.

13. The method according to claim 1, characterized by determining the positions of the markings on the layers of fibre material by means of a laser.

14. The method according to claim 1, characterized by comparing the determined positions of the markings on the layers of fibre material with the predetermined reference positions for said markings by means of a computer.

15. The method according to claim 1, characterized by performing correction of the position of said layer or layers of fibre material by means of an apparatus for the initial location of the layers of fibre material in the mould.

16. A system for, during manufacturing of a fibre-reinforced part for a wind power plant, monitoring and controlling that a plurality of layers of material comprising fibre for the manufacturing of said part are located correctly in a mould for said part and/or correctly relative to each other in said mould, characterized in that said system comprises:
while each layer of fibre material is provided with at least one marking and while the layers of fibre material are being located on top of each other or next to each other or with overlapping edges in the mould, means for determining the position in the mould of each marking on each layer of fibre material and/or the positions of the markings on different layers of fibre material relative to each other,
means for comparing the determined position in the mould of each marking on each layer of fibre material and/or the positions of the markings on said different layers of fibre material relative to each other with predetermined reference positions for said markings for the part to be manufactured, and
means for performing correction of the position of that or those layers of fibre material for which the determined positions for the markings thereon and the predetermined reference positions for said markings do not correspond with each other.

17. The system according to claim 16, characterized in that said means for determining the positions of the markings on the layers of fibre material is a camera.

18. The system according to claim 16, characterized in that said means for determining the positions of the markings on the layers of fibre material is a laser.

19. The system according to claim 16, characterized in that said means for comparing the determined positions of the markings on the layers of fibre material with predetermined reference positions for said markings for the part to be manufactured is a computer.

20. The system according to claim 16, characterized in that said means for performing correction of the position of that or those layers of fibre material for which the determined positions for the markings thereon and the predetermined reference positions for said markings do not correspond with each other, is an apparatus by means of which the layers of fibre material are initially located in the mould.
